(19) United States
(12) Patent Application Publication
(10) Pub. No.: US 2026/0238096 A1
(43) Pub. Date: Aug. 13, 2026

(54) LOW-TEMPERATURE CURABLE, HIGH GLASS TRANSITION TEMPERATURE ADHESIVE COMPOSITIONS FOR BONDING MAGNETS IN ELECTRIC AND HYBRID ELECTRIC VEHICLE MOTORS AND ASSOCIATED METHODS FOR USING THE SAME

(71) Applicants: Thanikaivelan Tindivanam Veeraraghavan, Newburgh, IN (US); Karthikeyan Sengotaiyan, Newburgh, IN (US); Senthilkumar Veeraraghavan, Newburgh, IN (US)

(72) Inventors: Thanikaivelan Tindivanam Veeraraghavan, Newburgh, IN (US); Karthikeyan Sengotaiyan, Newburgh, IN (US); Senthilkumar Veeraraghavan, Newburgh, IN (US)

(21) Appl. No.: 19/050,381

(22) Filed: Feb. 11, 2025

(51) Int. Cl. H02K 15/035; C09J 11/04; C09J 11/06; C09J 163/10; H02K 1/28

(52) U.S. Cl. CPC H02K 15/035; C09J 11/04; C09J 11/06; C09J 163/10; H02K 1/28

(57) ABSTRACT

A one-component adhesive composition adapted for bonding permanent magnets to motor rotors including a blend of epoxy resins that contain DGEBA, DGEBF, and a multifunctional epoxy resin, along with an epoxy-terminated polyurethane toughener and a latent hardener system. The composition can be cured at temperatures as low as 100° C. while achieving glass transition temperatures above 120° C. The cured adhesive exhibits excellent bond strength, thermal stability, and dimensional stability at elevated temperatures, making it particularly suitable for use in electric and hybrid electric vehicle motors.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to adhesive compositions, and, more particularly, to epoxy-based adhesive compositions adapted for bonding permanent magnets to rotors in electric and hybrid electric vehicle motors. The invention specifically relates to one-component epoxy adhesive compositions that can be cured at relatively low temperatures while achieving high glass transition temperatures, and to methods of using such compositions.

### 2. Background of the Invention

Electric and hybrid electric vehicles (EV/HEV) rely on electric motors for propulsion. These motors typically contain permanent magnets that must be securely bonded to the rotor core. The adhesive used for this bonding must withstand high rotational speeds and elevated operating temperatures while maintaining dimensional stability and bond strength.

Conventional magnet bonding adhesives often require high curing temperatures, typically at least 120-150° C. for 30 minutes or more. These high curing temperatures can be problematic as they may affect the magnetic properties of the permanent magnets and increase manufacturing energy costs. Additionally, many existing adhesives that cure at lower temperatures fail to achieve the high glass transition temperatures (Tg) necessary for stable performance at motor operating temperatures.

Furthermore, the bonding process must account for manufacturing tolerances in both the magnets and rotor cores while ensuring precise positioning to prevent imbalances that could be harmful in high-performance machines. The adhesive must also provide sufficient bond strength under various conditions including elevated temperatures, high humidity, and exposure to various automotive fluids.

There remains a need for magnet bonding adhesives that can cure at lower temperatures while achieving high glass transition temperatures and maintaining excellent bond strength under real world operating conditions.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention addresses the challenges of magnet bonding in electric vehicle motors through an innovative one-component epoxy adhesive system. This novel approach enables secure bonding of permanent magnets to motor rotors while achieving both low-temperature curability and high-temperature performance. The technology is based on a novel combination of epoxy resins, toughening agents, and hardener systems to enable unprecedented processing and performance characteristics.

In one embodiment, the present invention is directed to a novel, specialized epoxy adhesive composition for bonding magnets to motor rotors, comprising, consisting essentially of and/or consisting of: (a) a first epoxy resin comprising a diglycidyl ether of bisphenol A (DGEBA) having an epoxy equivalent weight of 184-190 g/eq; (b) a second epoxy resin comprising a diglycidyl ether of bisphenol F (DGEBF) having an epoxy equivalent weight of 160-180 g/eq; (c) a third epoxy resin selected from a naphthalene-type tetrafunctional epoxy resin, a trifunctional epoxy resin, and/or a DCPD-based epoxy resin; (d) a toughening system comprising an epoxy resin/ABS rubber blend and a bisphenol-capped polyurethane toughener; (e) an aluminum trihydrate filler; (f) a latent hardener system comprising dicyandiamide, imidazole catalyst, and substituted urea; (g) an epoxy diluent; (h) a silane adhesion promoter; (i) a phosphoric acid ester wetting agent; and (j) a fumed silica rheology modifier.

In another embodiment, the present invention is directed to a novel, specialized epoxy adhesive composition for bonding magnets to motor rotors, comprising, consisting essentially of and/or consisting of: (a) a first epoxy resin component comprising DGEBF and DGEBA in a weight ratio of 4.5:1 to 5:1; (b) a second epoxy resin component comprising a rigid multifunctional epoxy resin selected from naphthalene-type tetrafunctional epoxy resin, trifunctional epoxy resin, and DCPD-based epoxy resin, wherein the weight ratio of the first epoxy resin component to the second epoxy resin component is 2.1:1 to 2.2:1; (c) a toughening system comprising an epoxy resin/ABS rubber blend and a bisphenol-capped polyurethane in a weight ratio of 0.65:1 to 0.75:1; (d) aluminum trihydrate filler in a weight ratio to total epoxy resins of 0.22:1 to 0.25:1; (e) a latent curing system comprising: dicyandiamide, imidazole catalyst, and substituted urea in a weight ratio of 8:3:1; (f) an epoxy diluent present in a weight ratio to the first epoxy resin component of 0.2:1 to 0.22:1; and (g) a combination of functional additives comprising silane adhesion promoter, phosphoric acid ester wetting agent, and fumed silica in a weight ratio of 1.8:1:1; and wherein the composition exhibits a glass transition temperature above 160° C. when cured at 150° C. for 30 minutes, and wherein all components are present in amounts such that they total 100 weight percent of the composition.

The compositions of the present invention exhibit unprecedented rheological properties that enable practical industrial application. At room temperature, the materials maintain moderate viscosity (50-70 Pa-s) for excellent application characteristics. When heated for curing, the composition demonstrates rapid cure response while maintaining dimensional stability.

The invention encompasses both the compositions and methods for their applications in EV motor assembly. The adhesives can be cured under various time-temperature combinations ranging from 100° C. for 60 minutes to 200° C. for 4 minutes, providing manufacturing flexibility while consistently achieving high performance properties.

In another embodiment, the present invention is directed to methods for bonding permanent magnets to motor rotors using the adhesive compositions, comprising the steps of: (a) applying the adhesive composition to the magnet and/or the rotor surface; (b) positioning the magnet relative to the rotor; and (c) curing the adhesive at a temperature between 100° C. and 200° C.

This novel system provides several significant advantages over conventional methods, including: simplified one-component handling, reduced curing temperatures, superior thermal performance, and excellent mechanical properties.

The cured adhesives exhibit an exceptional combination of properties that exceed conventional systems, including, but not limited to:

### Mechanical Properties:

Lap shear strength>35.0 MPa at room temperature
Lap shear strength>20.0 MPa at 160° C.
T-peel strength>10 N/mm
Young's modulus>0.50 GPa
Elongation>2%

### Thermal Properties:

Glass transition temperature>120° C.
Thermal conductivity>0.5 W/m·K
Coefficient of thermal expansion: 51-57 ppm/° C.
UL94 V-0 flame rating

### Processing Properties:

Viscosity at 25° C.: 50-70 Pa·s
One-component storage stability
Cure temperature as low as 100° C.
Multiple cure schedules available

### BRIEF DESCRIPTION OF THE DRAWINGS

Certain embodiments of the present invention are illustrated by the accompanying figures. It will be understood that certain figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 is a cross-sectional view of an electric vehicle motor showing magnets adhesively associated with the rotor according to an embodiment of the present invention;

FIG. 2 illustrates a thermomechanical analysis (TMA) curve for Experiment 1, wherein dimensional change (%) is plotted as a function of temperature (C);

FIG. 3 illustrates a thermomechanical analysis (TMA) curve for Experiment 2, wherein dimensional change (%) is plotted as a function of temperature (° C.); and

FIG. 4 illustrates a thermomechanical analysis (TMA) curve for Experiment 3, wherein dimensional change (%) is plotted as a function of temperature (C).

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

### Definitions

As used herein, the following terms have the following meanings:

EV/HEV refers to electric vehicles and hybrid electric vehicles.

Glass transition temperature (Tg) refers to the temperature at which the adhesive transitions from a hard, glassy state to a softer, rubbery state.

Approximately/about +/−2% when the total concentration of the relevant component is above 5% and +/−0.2% when the total concentration of the relevant component is below 5%.

EEW refers to epoxy equivalent weight, defined as the weight of resin in grams that contains one gram equivalent of epoxy groups.

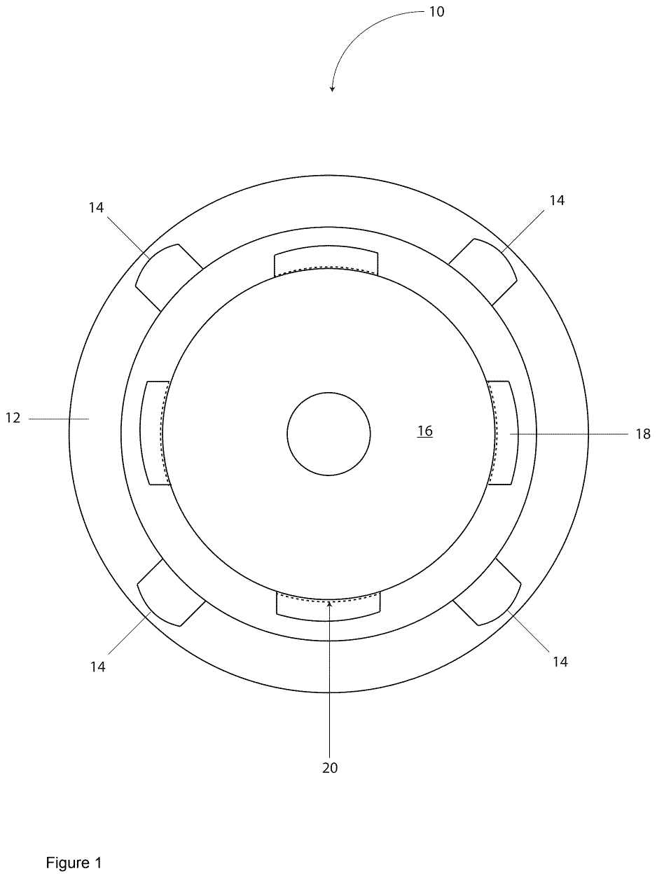

Referring now to the drawings, and to FIG. 1 in particular, the present invention is directed to, in one embodiment, an electric vehicle motor 10, comprising: a stator core 12 having a hairpin or winding portions 14, and an internal rotor 16 having permanent magnets 18 adhesively secured to at least a portion of rotor 16 with adhesive 20 of the present invention. The permanent magnets 18 preferably comprise either neodymium-iron-boron (Nd2Fe14B) with energy products ranging from 30-52 MGOe and Curie temperatures of 310-400° C., or samarium-cobalt (SmCo5 or Sm2Co17) with energy products of 20-32 MGOe and superior high-temperature stability up to 350° C. The rotor 16 is preferably constructed from silicon steel laminations containing 2.8-3.2% Si by weight, with individual lamination thicknesses ranging from 0.20-0.35 mm, wherein said laminations are stacked and bonded to form the rotor core. The adhesive 20 may be applied to either the magnet surface, the rotor surface, or both surfaces in a layer ranging from 0.25 mm to 3.0 mm in thickness, with a preferred thickness of 0.5-1.0 mm to optimize both bond strength and thermal conductivity. The adhesive 20 can be applied through various methods including: automated dispensing with a precision metering system, screen printing for high-volume production, stencil printing for precise deposit control, or transfer pad printing when working with complex geometries. For magnets 18 having dimensions typically ranging from 30-100 mm in length and 10-30 mm in width, the adhesive 20 is preferably applied in a controlled pattern of parallel beads or a continuous layer to ensure uniform coverage and eliminate air entrapment. The bond line thickness may be controlled through the use of precision glass beads or polyamide spacers having diameters matching the desired adhesive thickness, thereby ensuring consistent magnet positioning and optimized adhesive performance.

As will be discussed in detail herein below, adhesive 20 of the present invention is a one-component epoxy adhesive composition particularly suitable for bonding permanent magnets to motor rotors in electric and hybrid electric vehicles. The adhesive composition achieves novel and advantageous combinations of properties including low temperature curability, high glass transition temperature, excellent bond strength, and good thermal conductivity.

The adhesive compositions of the present invention preferably comprise an epoxy component, a toughener, and a hardener. In certain embodiments, the compositions further comprise at least one component selected from the group consisting of a filler and a curing accelerator.

In one embodiment, the present invention is directed to a novel, specialized epoxy adhesive composition, comprising, consisting essentially of and/or consisting of: a first epoxy resin, a second epoxy resin, a third epoxy resin preferably selected from the group consisting of: trifunctional epoxy resins, dicyclopentadiene (DCPD) epoxy resins, and/or naphthalene-type multifunctional epoxy resins, an epoxy resin/ABS rubber blend and a bisphenol-capped polyurethane toughener, a thermal conductive filler, a viscosity control agent (e.g., a cycloaliphatic epoxy diluent), a latent hardener system, an adhesion promoter; a wetting agent; and a rheology modifier.

### Adhesive Composition Components

### Epoxy Resins

The epoxy component preferably comprises at least one epoxy resin selected from the group consisting of difunctional epoxy resins, trifunctional epoxy resins, and tetrafunctional epoxy resins. In particular embodiments, the epoxy component comprises at least one member selected from the group consisting of liquid epoxy resins and solid epoxy resins.

In certain embodiments, the epoxy component comprises a combination of multifunctional epoxy resins. The epoxy resins may be independently selected from solid epoxy resins and liquid epoxy resins. In preferred embodiments, the epoxy component comprises a combination of at least one solid epoxy resin and at least one liquid epoxy resin, wherein the relative proportions of the solid and liquid epoxy resins are adjusted to achieve a composition having a predetermined viscosity, thereby enhancing processability of the composition.

The multifunctional epoxy resins may include any suitable multifunctional epoxy resin or combination thereof. In preferred embodiments, the difunctional epoxy resins comprise diglycidyl ethers of a bisphenol. In other preferred embodiments, the difunctional epoxy resins comprise diglycidyl ethers of bisphenol A (DGEBA epoxy resins).

The adhesive composition preferably comprises multiple epoxy resins selected and combined to achieve unprecedented properties. The epoxy component preferably includes a difunctional epoxy resin comprising DGEBA having an EEW of 184-190 g/eq. The DGEBA epoxy resin may be present in an amount ranging from about 5 to about 20 parts by weight, based on 100 parts by weight of the epoxy adhesive composition. More preferably, the DGEBA epoxy resin ranges from about 5 to about 8 parts by weight. The epoxy component also preferably includes a difunctional epoxy resin comprising DGEBF having an EEW of 160-180 g/eq. The DGEBF epoxy resin may be present in an amount ranging from about 25 to about 60 parts by weight, based on 100 parts by weight of the epoxy adhesive composition. More preferably, the DGEBF epoxy resin ranges from about 30 to about 33 parts by weight. The epoxy component also preferably includes a multifunctional epoxy resin selected from: naphthalene-type tetrafunctional epoxy resins (EEW 230-244), tris-(hydroxyl phenyl)-methane-based epoxy resins (EEW 150-170), and DCPD-based epoxy resins (EEW 230-260) present in an amount of 10-25 weight percent. The multifunctional epoxy resin may be present in an amount ranging from about 10 to about 25 parts by weight, based on 100 parts by weight of the epoxy adhesive composition. More preferably, the multifunctional epoxy resin ranges from about 17 to about 20 parts by weight.

The combination of different epoxy resins provides an unprecedented balance of properties including processability, cure speed, and final mechanical properties.

### Bisphenol A Based Epoxy Resins

The epoxy resin system forms the foundation of the composition through a carefully optimized blend of components. One preferred primary component is a bisphenol A based epoxy resin, specifically a diglycidyl ether of bisphenol A (DGEBA), which provides the basic network structure for the cured system and comprises the following chemical structure.

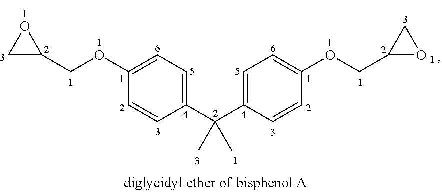 [SMILES: CC(C)(c1ccc(OCC2CO2)cc1)c1ccc(OCC2CO2)cc1]

This resin is selected for its combination of properties including good adhesion to metal substrates, excellent electrical insulation characteristics, and balanced mechanical properties after cure.

The DGEBA resin comprises approximately 5-20 weight percent of the total composition and typically has an epoxy equivalent weight between 184-190 g/eq. This molecular weight range has been found ideal for achieving the desired balance of uncured viscosity and cured properties. Commercial examples include YD128 from Kukdo Chemical Company, which provides excellent batch-to-batch consistency and reliable performance.

Further preferred epoxy resins that are commercially available include epoxy compounds selected from: octadecylene oxide; epichlorohydrin; styrene oxide; vinyl cyclohexene oxide; glycidol; glycidyl methacrylate; diglycidyl ethers of bisphenol A (including those commercially available under the trade designations EPON™ 828, EPONT 825, EPONT 1004, and EPON™ 1010 from Hexion Specialty Chemicals Inc., and DER™-331, DER™-332, DER™-334, DER™-732, and DER™-736 from Dow Chemical Company); vinylcyclohexene dioxide; 3,4-epoxycyclohexylmethyl-3,4-epoxycyclohexene carboxylate; 3,4-epoxy-6-methylcyclohexylmethyl-3,4-epoxy-6-methylcyclohexene carboxylate; bis(3,4-epoxy-6-methylcyclohexylmethyl) adipate; bis(2,3-epoxycyclopentyl) ether; aliphatic epoxide modified with polypropylene glycol; dipentene dioxide; and 2-epoxyhexadecane.

The commercially available epoxy resins further comprise alkyl glycidyl ethers including: C8-C10 alkyl glycidyl ethers (commercially available as HELOXY™ Modifier 7 from Hexion Specialty Chemicals Inc.); C12-C14 alkyl glycidyl ethers (commercially available as HELOXY™ Modifier 8 from Hexion Specialty Chemicals Inc.); butyl glycidyl ethers (commercially available as HELOXY™ Modifier 61 from Hexion Specialty Chemicals Inc.); cresyl glycidyl ethers (commercially available as HELOXY™ Modifier 62 from Hexion Specialty Chemicals Inc.); and p-tert-butylphenyl glycidyl ethers (commercially available as HELOXY™ Modifier 65 from Hexion Specialty Chemicals Inc.).

The commercially available epoxy resins additionally comprise polyfunctional glycidyl ethers including: diglycidyl ethers of 1,4-butanediol (commercially available as HELOXY™ Modifier 67 from Hexion Specialty Chemicals Inc.); diglycidyl ethers of neopentyl glycol (commercially available as HELOXY™ Modifier 68 from Hexion Specialty Chemicals Inc.); diglycidyl ethers of cyclohexanedimethanol (commercially available as HELOXY™ Modifier 107 from Hexion Specialty Chemicals Inc.); trimethylolethane triglycidyl ethers (commercially available as HELOXY™ Modifier 44 from Hexion Specialty Chemicals Inc.); trimethylolpropane triglycidyl ethers (commercially available as HELOXY™ Modifier 48 from Hexion Specialty Chemicals Inc.); polyglycidyl ethers of an aliphatic polyol (commercially available as HELOXY™ Modifier 84 from Hexion Specialty Chemicals Inc.); polyglycol diepoxide (commercially available as HELOXY™ Modifier 32 from Hexion Specialty Chemicals Inc.); bisphenol F epoxies (commercially available as EPN-1138™ or GY-281™ from Huntsman Int, LLC); and 9,9-bis[4-(2,3-epoxypropoxy)phenyl] fluorenone (commercially available as EPON™ 1079 from Hexion Specialty Chemicals Inc.).

### High Purity Bisphenol F Based Epoxy Resins

One preferred primary component is a bisphenol F based epoxy resin, specifically a diglycidyl ether of bisphenol A (DGEBF), which provides the basic network structure for the cured system and comprises the following chemical structure:

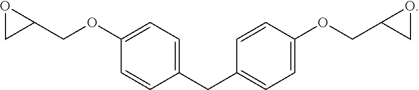 [SMILES: c1cc(OCC2CO2)ccc1Cc1ccc(OCC2CO2)cc1]

The DGEBF resin comprises approximately 25-60 weight percent of the total composition and typically has an epoxy equivalent weight between 160-180 g/eq.

In accordance with the present invention, the high purity epoxy resin component preferably comprises high purity Bisphenol A (BPA), high purity Bisphenol F (BPF), or combinations thereof. The component exhibits a viscosity ranging from 800 to 8000 mPa·s at standard conditions. The high purity epoxy resin component is characterized by high monomer content, low hydroxy value, and reduced concentrations of by-products and impurities, resulting in moderated reactivity when combined with the amine curing agent.

The moderated reactivity profile of the present epoxy resin system advantageously facilitates enhanced impregnation of reinforcement materials during composite processing via infusion methods. This characteristic substantially contributes to the elimination of process defects, including but not limited to dry areas and wrinkles in the final composite structure.

In accordance with an embodiment of the present disclosure, the high purity epoxy resin component contains total by-products and impurities at a concentration of less than 5,000 parts per million (ppm). These by-products and impurities may comprise hydrolysable chlorine, alpha glycol, moisture, and volatile organic compounds, wherein the concentration of any individual impurity does not exceed 1,000 ppm.

The high purity epoxy resin component, specifically the high purity Bisphenol A (BPA) and high purity Bisphenol F (BPF), may be obtained through conventional purification methodologies, including but not limited to filtration and distillation processes. Alternatively, commercially available high purity Bisphenol A (BPA) or high purity Bisphenol F (BPF) meeting the aforementioned specifications may be utilized in the present invention.

### Naphthalene Based Epoxy Resins

The adhesive compositions of the present invention may also include

naphthalene-based epoxy resins. The naphthalene-based epoxy resin encompasses a broad range of compounds, including but not limited to epoxy resins distinct from the previously described naphthalene aralkyl-based epoxy resins. These compounds specifically comprise naphthalene backbone-containing polyfunctional epoxy resins and epoxy resins incorporating a naphthalene backbone structure. Among these, naphthalene ether-based epoxy resins represent a preferred embodiment, particularly for their enhanced properties including superior chemical resistance, improved adhesion to copper foil, and enhanced insulating reliability. The naphthalene backbone-containing polyfunctional epoxy resin may be obtained through either commercial sources or synthesis via established methodologies. Commercial sources include, but are not limited to, products manufactured by DIC Corporation, specifically HP-4710, HP-9540, and HP-9500. Additional examples include those having the following chemical structures:

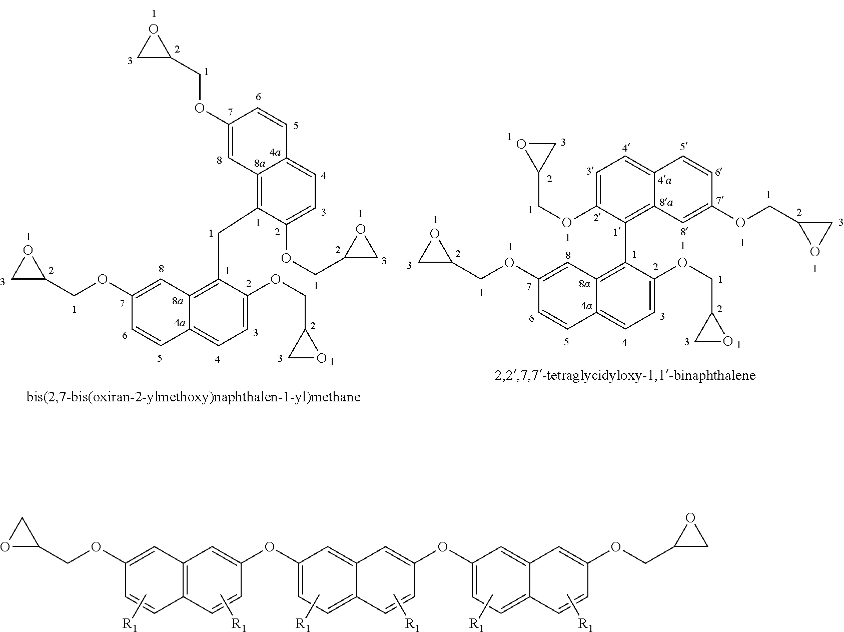

wherein each one of R₁ independently is a hydrogen atom, a hydroxyl group, an 5 alkyl group having from 1 to 3 carbon atoms (e.g., a methyl group or an ethyl group), or an alkenyl group having from 2 to 3 carbon atoms (e.g., a vinyl group, an allyl group, or a propenyl group); and

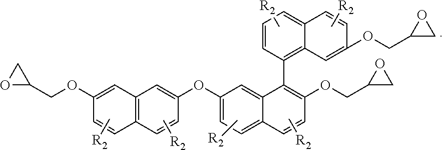

wherein each one of R₂ independently is a hydrogen atom, a hydroxyl group, an alkyl group having from 1 to 3 carbon atoms (e.g., a methyl group or an ethyl group), or an alkenyl group having from 2 to 3 carbon atoms (e.g., a vinyl group, an allyl group, or a propenyl group).

The naphthalene-based epoxy resins may be present in an amount ranging from about 10 to about 25 parts by weight, based on 100 parts by weight of the epoxy adhesive composition. More preferably, the naphthalene-based epoxy resins range from about 15-20 parts by weight.

### Dicyclopentadiene Based Epoxy Resins

The adhesive compositions of the present invention may also include dicyclopentadiene (DCPD) based epoxy resins. The dicyclopentadiene-based epoxy resins employed in the present invention are not particularly limited in their structure. The resin may be selected from commercially available products or may be prepared according to methods known in the art. Representative commercial examples of suitable dicyclopentadiene-based epoxy resins include EPICRON HP-7200L, EPICRON HP-7200, EPICRON HP-7200H, and EPICRON HP-7200HH, manufactured by Dainippon Ink Chemical Industries, Ltd.

The adhesive compositions of the present invention may also include dicyclopentadiene based epoxy resins having the following chemical structure:

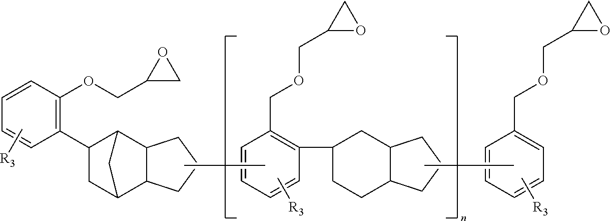

wherein each one of Rs independently represents a hydrogen atom or an alkyl group having from 1 to 5 carbon atoms, and n represents an integer from 0 to 10.

The DCPD-based epoxy resins may be present in an amount ranging from about 10 to about 25 parts by weight, based on 100 parts by weight of the epoxy adhesive composition. More preferably, the DCPD-based epoxy resins range from about 15-20 parts by weight.

### Trifunctional Epoxy Resins

The adhesive compositions of the present invention may also include trifunctional epoxy resins. In certain embodiments, the trifunctional epoxy resin is selected from: (a) tris [4-(2,3-epoxypropoxy)phenyl] methane (commercially available as TACTIX® 742 from Huntsman Corporation); (b) N,N,N′,N′-tetraglycidyl-4,4′-methylenebisbenzenamine (commercially available as TGMDA or MY-720@ from Huntsman Corporation); (c) triglycidyl p-aminophenol (commercially available as MY-0510® from Huntsman Corporation); (d) 1,3,5-tris(2,3-epoxypropoxy)benzene (commercially available as ERM-1360® from Emerald Performance Materials); (e) triglycidyl isocyanurate (TGIC, commercially available as TEPIC® from Nissan Chemical Industries); (f) triglycidyl trimellitate (commercially available as TG™® from Hexion); (g) triglycidyl tris(2-hydroxyethyl) isocyanurate; and (h) 4,4′,4″-(1,3,5-triazine-2,4,6-triyl)tris(N,N-bis(2,3-epoxypropyl) aniline). In a preferred embodiment, the trifunctional epoxy resin is tris [4-(2,3-epoxypropoxy)phenyl] methane (TACTIX® 742).

The adhesive compositions of the present invention may also include a trifunctional epoxy resin having the following chemical structure:

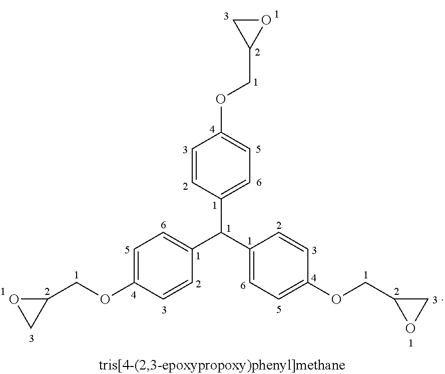 [SMILES: c1cc(C(c2ccc(OCC3CO3)cc2)c2ccc(OCC3CO3)cc2)ccc1OCC1CO1]

The trifunctional epoxy resins may be present in an amount ranging from about 10 to about 25 parts by weight, based on 100 parts by weight of the epoxy adhesive composition. More preferably, the trifunctional epoxy resins range from about 15-20 parts by weight.

### Rubber Dispersed Epoxy Resin

The adhesive compositions of the present invention also preferably include rubber dispersed epoxy resins.

The rubber particles preferably comprise a polymeric material having elastomeric or rubbery properties, wherein the polymeric material has a glass transition temperature of less than 0° C., preferably less than −30° C.

The rubber particles comprise at least one polymer selected from the group consisting of diene homopolymers, diene copolymers, and polysiloxanes. The diene homopolymers are selected from the group consisting of polybutadiene and polyisoprene. The diene copolymers comprise: (1) at least one diene monomer selected from the group consisting of butadiene and isoprene; and (2) at least one ethylenically unsaturated monomer selected from the group consisting of vinyl aromatic monomers, (meth)acrylonitrile, and (meth)acrylates.

The rubber particles optionally comprise functional groups selected from the group consisting of carboxylate groups and hydroxyl groups. The rubber particles may have a structure selected from the group consisting of linear structures, branched structures, crosslinked structures, random copolymer structures, and block copolymer structures.

In one embodiment, the rubber particles are formed predominantly from feed stocks comprising at least one monomer selected from the group consisting of butadiene, (meth)acrylates, and ethylenically unsaturated nitriles, wherein the ethylenically unsaturated nitriles comprise acrylonitrile, and wherein polymerization or copolymerization of said at least one monomer yields a polymer or copolymer having a glass transition temperature less than 0° C.

The rubber particles are provided in a form selected from the group consisting of a dry form and a dispersion in a matrix. The matrix comprises a material selected from the group consisting of epoxy matrices and phenolic matrices, wherein the matrix material is liquid at room temperature. The epoxy matrices are selected from the group consisting of diglycidyl ethers of bisphenol A, diglycidyl ethers of bisphenol F, diglycidyl ethers of bisphenol S, bisphenol novolac epoxies, and cycloaliphatic epoxies.

Non-limiting examples include: Core-shell butadiene-styrene rubber particles (SBR), such as Kane Ace™ MX-153, having a butadiene core and styrene shell structure with a glass transition temperature of approximately-55° C., typically provided as a dispersion in DGEBA epoxy resin; Carboxyl-terminated butadiene-acrylonitrile rubber particles (CTBN), such as Hycar™ CTBN 1300X8, having a glass transition temperature of approximately −50° C. and containing approximately 0.4 mmol/g of carboxyl groups; Hydroxyl-terminated polybutadiene rubber particles (HTPB), such as Poly bd™ R-45HTLO, having a glass transition temperature of approximately −75° C. and containing terminal hydroxyl groups; Modified polysiloxane rubber particles, such as KER 2003™, having a glass transition temperature below −80° C. and typically dispersed in bisphenol A epoxy resin; and Block copolymer rubber particles based on styrene-butadiene-styrene (SBS), such as Kraton™ D1101, having a glass transition temperature of approximately −70° C. for the butadiene segment.

The rubber dispersed epoxy resins may be present in an amount ranging from about 5 to about 15 parts by weight, based on 100 parts by weight of the epoxy adhesive composition. More preferably, the rubber dispersed epoxy resins range from about 6-12 parts by weight.

### Toughening Agents

The adhesive compositions of the present invention preferably comprises a toughener, such as a polyphenolic blocked polyurethane (“polyphenolic blocked PU”). The polyphenolic blocked PU increases the impact peel strength of the cured adhesive. The polyphenolic blocked PU comprises a liquid or low-melting elastomeric material containing capped or blocked isocyanate groups.

The elastomeric portion of the polyphenolic blocked PU comprises at least one soft segment selected from the group consisting of a polyether, a polybutadiene, and a polyester. The soft segment is preferably selected from the group consisting of poly(ethylene oxide) blocks, poly(propylene oxide) blocks, poly(ethylene oxide co-propylene oxide) blocks, poly(butylene oxide) blocks, poly(tetrahydrofuran) blocks, and poly(caprolactone) blocks. The soft segments have a molecular weight ranging from 1,000 to 10,000 Daltons, preferably from 1,500 to 5,000 Daltons. In one embodiment, the soft segment comprises a poly(tetrahydrofuran) block having a molecular weight ranging from 2,200 to 4,500 Daltons.

The polyphenolic blocked PU comprises at least one blocked or capped isocyanate group per molecule, preferably an average of at least 2 blocked or capped isocyanate groups per molecule, and no more than 6 blocked or capped isocyanate groups per molecule, more preferably no more than 4 blocked or capped isocyanate groups per molecule.

The capping or blocking groups are selected from the group consisting of phenols, phenol amines, primary aliphatic amines, primary cycloaliphatic amines, primary heteroaromatic amines, primary aromatic amines, secondary aliphatic amines, secondary cycloaliphatic amines, secondary aromatic amines, secondary heteroaromatic amines, monothiols, alkyl amides, hydroxyl functional epoxides, and benzyl alcohols. The capping or blocking group optionally comprises at least one functional group selected from the group consisting of phenol groups, aromatic amino groups, —OCN groups, and epoxide groups, or may comprise further polyurethane elastomers bound thereto. In preferred embodiments, the capping group comprises a secondary aliphatic amine, a hydroxyalkyl epoxide, a phenol, an amino phenol, a polyphenol, an allylphenol, or a polyallyl polyphenol, wherein the polyallyl polyphenol preferably comprises o-diallyl bisphenol A.

In one embodiment, the polyphenolic blocked PU is prepared by: (1) forming an isocyanate-terminated prepolymer; and (2) reacting remaining isocyanate groups with the capping or blocking agent. The isocyanate-terminated prepolymer is prepared by reacting a polyol selected from the group consisting of polyether polyols and polyester polyols with an excess of a polyisocyanate, wherein the polyisocyanate preferably comprises aliphatic isocyanate groups. Preferred polyisocyanates include hexamethylene diisocyanate and isophorone diisocyanate.

The polyphenolic blocked PU is soluble or dispersible in remaining components of a resin component A. The polyphenolic blocked PU has a viscosity at 45° C. of not greater than 1,000 Pa-s, preferably not greater than 800 Pa·s. The polyphenolic blocked PU has a weight average molecular weight of at least 8,000, preferably at least 10,000, and not greater than 80,000, preferably not greater than 40,000, as determined by GPC analysis.

The composition preferably comprises from 5 to 30 weight percent of the polyphenolic blocked PU, preferably from 7 to 10 weight percent, based on the total weight of the composition, wherein the amount is sufficient to beneficially affect the impact peel strength of the cured adhesive.

The composition preferably includes 5-10 weight percent of an epoxy-terminated polyurethane toughener, preferably a bisphenol-capped polyurethane. The toughener enhances the impact resistance and peel strength of the cured adhesive without significantly compromising its high temperature performance.

In one preferred aspect of the present invention, the toughening agent comprises an epoxy terminated polyurethane interpenetrating network represented by the following chemical structure:

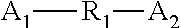

wherein A₁ is represented by the following chemical structure:

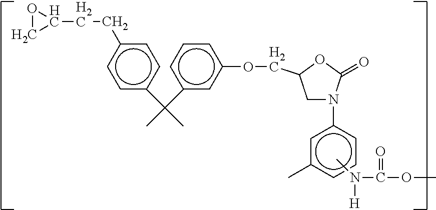

wherein R₁ comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 75 carbon atoms, an oligomer, and/or a polymer; and wherein A₂=A₁ and/or comprises an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 35 carbon atoms, an oligomer, and/or a polymer.

In another preferred embodiment of the present invention, the toughening agent comprises an epoxy terminated polyurethane interpenetrating network represented by the following chemical structure:

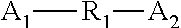

wherein A₁ is represented by the following chemical structure:

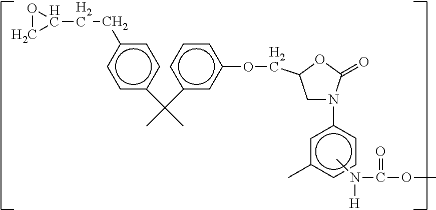

wherein R₁ comprises an alkyl, alkenyl, and/or alkynyl group containing approximately 1 to approximately 36 carbon atoms, an oligomer, and/or a urethane polymer; and wherein A₂=A₁.

### Reactive Diluents

The adhesive compositions of the present invention preferably comprise a reactive diluent, wherein said reactive diluent comprises a monomeric epoxy-containing molecule. The reactive diluent preferably comprises a cyclic backbone selected from the group consisting of saturated cyclic backbones and unsaturated cyclic backbones. The reactive diluent comprises a terminal portion comprising a glycidyl ether group.

The reactive diluent is preferably selected from the group consisting of diglycidyl ether of resorcinol, diglycidyl ether of neopentyl glycol, and triglycidyl ether of trimethylolpropane. In certain embodiments, the reactive diluent preferably comprises commercially available reactive diluents selected from the group consisting of ERISYS® GE-22 (a low viscosity, cycloaliphatic diepoxide, epoxidized cyclohexanedimethanol-available from Huntsman Corporation) and HELOXY® Modifier 107 (available from Westlake Epoxy).

The adhesive compositions of the present invention may also include a reactive diluent having the following chemical structure:

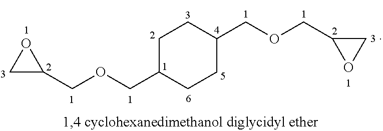 [SMILES: C1CC(COCC2CO2)CCC1COCC1CO1]

The reactive diluent may be present in an amount ranging from about 0 to about 15 parts by weight, based on 100 parts by weight of the epoxy adhesive composition. More preferably, the reactive diluent filler ranges from about 5-10 parts by weight.

### Conductive Fillers

The magnet bonding composition optionally comprises at least one conductive filler selected from the group consisting of silver, copper, boron nitride, alumina, gold, nickel, silver-containing alloys, copper-containing alloys, nickel-containing alloys, and combinations thereof. In preferred embodiments, the conductive filler is selected from the group consisting of silver, copper, boron nitride, and alumina, wherein said selection provides cost advantages.

When present, the conductive filler comprises from 10 to 25 weight percent of the epoxy adhesive composition, preferably from 15 to 20 weight percent, more preferably from 18 to 20 weight percent.

The composition optionally further comprises additional fillers and modifiers selected from the group consisting of: (a) fumed silica for increasing viscosity and reducing flow of the resin composition during processing and cure, wherein said fumed silica is selected from the group consisting of Cab-o-sil® M5, Cab-o-sil® TS720, and Aerosil® R₂₀₂; (b) pigments for imparting color to the composition, wherein said pigments comprise carbon black; (c) flame retardant materials selected from the group consisting of antimony oxide and brominated epoxy resins; and (d) thermally or electrically conductive materials selected from the group consisting of boron nitride, alumina, silver powder, and aluminum powder, wherein said materials impart thermal conductivity, electrical conductivity, or both thermal and electrical conductivity to the composition.

### Hardener System

The hardener system of the present invention preferably comprises: (1) from 2 to 10 weight percent of an amine curing agent, preferably dicyandiamide; (2) from 0.5 to 5 weight percent of a substituted urea accelerator; and (3) from 0.5 to 2 weight percent of an imidazole catalyst, wherein said combination provides storage stability at room temperature and rapid curing at elevated temperatures.

In preferred embodiments, the composition comprises a one-part or single-part component system configured to cure at elevated temperatures. The hardener system comprises at least one curing agent capable of accomplishing cross-linking or curing of the adhesive components when heated to a temperature above room temperature. The hardener is activated by heating and functions in either a catalytic manner or, in preferred embodiments, participates directly in the curing process through reaction with at least one adhesive component.

The thermally-activatable or latent hardeners are selected from the group consisting of guanidines, substituted guanidines, substituted ureas, melamine resins, guanamine derivatives, cyclic tertiary amines, aromatic amines, and combinations thereof. The hardeners function either stoichiometrically in the hardening reaction or catalytically. The substituted guanidines are selected from the group consisting of methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and cyanoguanidine (dicyandiamide). The guanamine derivatives comprise alkylated benzoguanamine resins, benzoguanamine resins, and methoxymethylethoxymethylbenzoguanamine.

For single-component, thermosetting adhesives, the hardener comprises a solid, finely ground material having low solubility at room temperature in the resin system, preferably dicyandiamide, thereby ensuring storage stability of the composition.

The composition optionally comprises catalytically-active substituted ureas selected from the group consisting of p-chlorophenyl-N,N-dimethylurea (monuron), 3-phenyl-1,1-dimethylurea (fenuron), and 3,4-dichlorophenyl-N,N-dimethylurea (diuron). The composition optionally comprises catalytically active tertiary acryl- or alkyl-amines selected from the group consisting of benzyl dimethylamine, tris(dimethylamino) phenol, piperidine, and piperidine derivatives.

The composition optionally comprises catalytically-active accelerators comprising solid imidazole derivatives selected from the group consisting of 2-ethyl-2-methylimidazole, N-butylimidazole, benzimidazole, N—C1-C12-alkylimidazoles, and N-arylimidazoles. In preferred embodiments, the composition comprises a combination of hardener and accelerator comprising finely ground accelerated dicyandiamides.

The composition optionally comprises at least one curing accelerator (catalyst) for modifying conditions under which a latent catalyst becomes catalytically active, wherein said curing accelerator provides improved cross-linking properties, increased E-modulus, improved curing profile, lower curing onset temperature, or combinations thereof. Reduction or elimination of curing accelerator increases the curing onset temperature by 10° C. to 30° C. and increases peak curing temperatures by 5° C. to 20° C., demonstrating delayed curing behavior.

The composition preferably comprises from 1 to 6 weight percent hardener, preferably from 2 to 5 weight percent, more preferably from 3 to 4 weight percent, based on the total weight of the epoxy adhesive. In certain embodiments, the hardener comprises 3.1, 3.3, or 3.6 weight percent of the composition. The weight ratio of epoxy to hardener ranges from 3:1 to 7:1, preferably from 4:1 to 6:1, wherein specific preferred ratios include 5:1, 5.75:1, and 6:1.

The adhesive compositions of the present invention may also include one or more hardeners having the following chemical structures:

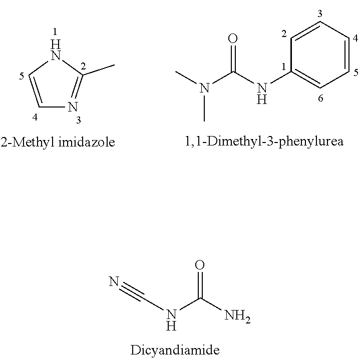

### Wetting Agent

The adhesive compositions of the present invention may also include one or more wetting agents. The composition optionally comprises at least one wetting agent comprising a phosphoric acid ester of Formula (I):

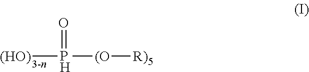

wherein n is an integer from 1 to 3, wherein the sum of OH groups and OR groups equals 3, wherein R is independently selected for each occurrence, and wherein R comprises a hydrocarbyl group.

The phosphoric acid ester comprises commercially available materials selected from the group consisting of BYK-W 9010 and BYK-W 996.

The wetting agent may be present in an amount ranging from 0 to about 0.7 parts by weight, based on 100 parts by weight of the epoxy adhesive composition. More preferably, the wetting agent ranges from about 0.4 to about 0.6 parts by weight.

### Adhesion Promoter

The adhesive compositions of the present invention may also include one or more adhesion promoters for improving adhesion of the cured adhesive to a substrate surface, preferably to a metallic substrate surface suitable for industrial applications.

The adhesion promoter preferably comprises at least one functional silane comprising: (1) a reactive component capable of bonding with the composition; (2) a silane modified material; and/or (3) a hydrolysable compound. The functional silane is preferably selected from the group consisting of: (a) 3-Glycidoxypropyltrimethoxysilane; (b) 3-Glycidoxypropylmethyldiethoxysilane; (c) 2-(3,4-Epoxycyclohexyl)-ethyltrimethoxysilane; (d) 2-(3,4-Epoxycyclohexyl)-ethyltriethoxysilane; and (e) combinations thereof.

The adhesive compositions of the present invention may also include a wetting agent having the following chemical structure:

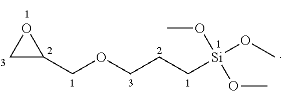

The wetting agent may be present in an amount ranging from 0 about 2.0 parts by weight, based on 100 parts by weight of the epoxy adhesive composition. More preferably, the wetting agent ranges from about 0.25 to about 0.75 parts by weight.

### Method of Preparation

The adhesive composition is prepared by:
1. Heating the epoxy resin/ABS rubber blend and multifunctional epoxy resin to 80° C. with mixing for 30 minutes
2. Adding the polyurethane toughener and mixing for 20 minutes at 80° C.
3. Adding DGEBA and DGEBF resins sequentially with 30 minutes mixing
4. Cooling to room temperature
5. Adding curing agents and mixing for 30 minutes
6. Adding fillers and mixing at high speed for 10 minutes
7. Adding remaining ingredients (silane, wetting agent, diluent) and mixing for 20 minutes
8. Final vacuum mixing for 40 minutes

### Curing Conditions

The adhesive can be cured under various time-temperature combinations including:
100° C. for 60 minutes
120° C. for 15 minutes
150° C. for 10 minutes
175° C. for 7 minutes
200° C. for 4 minutes

### Properties of Cured Adhesive

The cured adhesive exhibits the following properties:
Lap shear strength: >35.0 Mpa (ISO 4587)
T-peel strength: >10 N/mm (ASTM D1876)
Glass transition temperature: >120° C.
Thermal conductivity: >0.5 W/m·k
Young's modulus: >0.50 Gpa
Elongation: >2%
UL 94 V-0 flame rating
CLTE: 51-57 ppm/° C.

### Test Methods:

### Viscosity

Rheology is measured according to TA Discovery Hybrid rheometer HR 30, Method: 40 mm plate, 1000-micron gap, 1.5 shear rate, at 25 C.

Test Lap shear strength at Initial Lap shear strength is measured according to ISO 4587 by Instron tester 5900 series, Lap shear test rate-50 mm/min.

Test Lap shear strength at Elevated temperature:

Heat resistance: Cured specimens are heated to 100° C., 130° C., 160° C. and 200° C. for 1 day and then tested at corresponding temperatures.

Peel strength is measured according to ASTM D1876 by Instron tester 5900 series, Test rate.

Glass transition temperature measured according to TMA/SDTA 2+Mettler Toledo (-20C to 200C).

Thermal conductivity is measured according to ASTM D5470-12 method. Analysis Tech-TIM tester 1400.

Differential Scanning calorimetry is measure by Mettler Toledo. Interval 25-250° C., rate 10° C./min.

Modulus and elongation measured according to ASTM D638 by Instron tester 5900 series.

CLTE is measured by Mettler Toledo TMA/SDTA 2+Mettler Toledo (−20C to 200C).

Flame test-UL 94 V-0 flame test.

### Lap Shear Test Sample Preparation

The lap shear test sample preparation involves cleaning metal coupons of specified steel grade with acetone, followed by wiping with paper towels. The cleaned coupons are treated with 3 g/m² oil on one surface. The adhesive composition is applied to the oiled surface, followed by distribution of 0.2 mm glass beads across the adhesive layer before assembling the test coupons with a 10 mm overlap. Metal clips secure the assembly during thermal curing at 150° C. for 30 minutes unless otherwise specified.

### Preparation of One Component Magnet Bonding Experiments 1-3

### Adhesive Composition Experiment 1

| | Weight | |
|---|---|---|
| Component | % | Function |
| DGEBF epoxy resin | 31.06% | Primary epoxy resin |
| | | network structure and |
| | | mechanical properties |
| Trifunctional epoxy resins | 18.00% | Provides high crosslink |
| | | density and thermal |
| | | resistance |
| DGEBA epoxy resin | 6.65% | Secondary epoxy resin |
| | | for metal adhesion |
| Epoxy resin/ABS rubber blend | 6.22% | Impact resistance and |
| | | toughening |
| Bisphenol-capped Polyurethane | 8.90% | Impact and peel strength |
| Toughener | | enhancement |
| ATH (Aluminum trihydrate) filler | 12.38% | Thermal conductivity and |
| | | flame retardance |
| Erisys GE 22 Epoxy diluent | 7.50% | Viscosity control |
| Omicure DDA 10 | 5.00% | Primary amine curing agent |
| (Dicyandiamide) | | |
| Curizol 2MZ-Azinc | 1.75% | Imidazole catalyst |
| Technicure PDU 250M | 0.60% | Cure accelerator |
| (Substituted urea) | | |
| Silquest A-187 silane | 0.90% | Adhesion promoter |
| BYK 996 (Phosphoric acid ester) | 0.50% | Wetting agent |
| Fumed silica | 0.50% | Rheology modifier |

The preparation begins by heating 6.22 parts epoxy resin/ABS rubber blend with 18 parts trifunctional epoxy resins at 80° C. under continuous mixing for 30 minutes. 8.9 parts bisphenol-capped polyurethane toughener is added and maintained at 80° C. with mixing for 20 minutes. Then 6.65 parts DGEBA epoxy resin followed by 31.06 parts DGEBF epoxy resin are mixed for 30 minutes. After cooling to room temperature, curing agents are added (1.75 parts Curizol 2MZ-Azinc, 5.0 parts Omicure DDA 10, and 0.6 parts Technicure PDU 250M) and mixed for 30 minutes. 0.5 parts fumed silica and 12.38 parts ATH filler are dispersed at high speed for 10 minutes. Finally, 0.9 parts Silquest A 187 silane adhesion promoter, 0.5 parts BYK 996 wetting agent, and 7.5 parts Erisys GE 22 epoxy diluent are mixed at medium speed for 20 minutes at room temperature. The mixture undergoes final homogenization under vacuum at low speed for 40 minutes after thorough scraping.

Key Feature of Experiment 1: This experiment utilizes trifunctional epoxy resins as the primary functional resin component, which provides high crosslink density and thermal resistance.

### Adhesive Composition Experiment 2

| | Weight | |
|---|---|---|
| Component | % | Function |
| DGEBF epoxy resin | 31.06% | Primary epoxy resin |
| | | network structure and |
| | | mechanical properties |
| DCPD-epoxy resin | 18.00% | Provides improved |
| | | toughness and flexibility |
| | | via cycloaliphatic structure |
| DGEBA epoxy resin | 6.65% | Secondary epoxy resin |
| | | for metal adhesion |
| Epoxy resin/ABS rubber blend | 6.22% | Impact resistance and |
| | | toughening |
| Bisphenol-capped Polyurethane | 8.90% | Impact and peel strength |
| Toughener | | enhancement |
| ATH (Aluminum trihydrate) filler | 12.38% | Thermal conductivity |
| | | and flame retardance |
| Erisys GE 22 Epoxy diluent | 7.50% | Viscosity control |
| Omicure DDA 10 | 5.00% | Primary amine curing |
| (Dicyandiamide) | | agent |
| Curizol 2MZ-Azinc | 1.75% | Imidazole catalyst |
| Technicure PDU 250M | 0.60% | Cure accelerator |
| (Substituted urea) | | |
| Silquest A-187 silane | 0.90% | Adhesion promoter |
| BYK 996 (Phosphoric acid ester) | 0.50% | Wetting agent |
| Fumed silica | 0.50% | Rheology modifier |

The preparation begins by heating 6.22 parts epoxy resin/ABS rubber blend with 18 parts DCPD-epoxy resin at 80° C. under continuous mixing for 30 minutes. 8.9 parts bisphenol-capped polyurethane toughener is added and maintained at 80° C. with mixing for 20 minutes. Then 6.65 parts DGEBA epoxy resin followed by 31.06 parts DGEBF epoxy resin are mixed for 30 minutes. After cooling to room temperature, curing agents are added (1.75 parts Curizol 2MZ-Azinc, 5.0 parts Omicure DDA 10, and 0.6 parts Technicure PDU 250M) and mixed for 30 minutes. 0.5 parts fumed silica and 12.38 parts ATH filler are dispersed at high speed for 10 minutes. Finally, 0.9 parts Silquest A 187 silane adhesion promoter, 0.5 parts BYK 996 wetting agent, and 7.5 parts Erisys GE 22 epoxy diluent are mixed at medium speed for 20 minutes at room temperature. The mixture undergoes final homogenization under vacuum at low speed for 40 minutes after thorough scraping.

Key Feature of Experiment 2: This experiment employs DCPD-epoxy resin instead of trifunctional epoxy resins, offering improved toughness and flexibility due to the cycloaliphatic structure of DCPD.

### Adhesive Composition Experiment 3

| | Weight | |
|---|---|---|
| Component | % | Function |
| DGEBF epoxy resin | 31.06% | Primary epoxy resin |
| | | network structure and |
| | | mechanical properties |
| Naphthalene-type multi- | 18.00% | Provides enhanced |
| functional epoxy resins | | thermal properties and |
| | | chemical resistance due |
| | | to rigid aromatic structure |
| DGEBA epoxy resin | 6.65% | Secondary epoxy resin |
| | | for metal adhesion |
| Epoxy resin/ABS rubber blend | 6.22% | Impact resistance |
| | | and toughening |
| Bisphenol-capped Polyurethane | 8.90% | Impact and peel strength |
| Toughener | | enhancement |
| ATH (Aluminum trihydrate) filler | 12.38% | Thermal conductivity |
| | | and flame retardance |
| Erisys GE 22 Epoxy diluent | 7.50% | Viscosity control |
| Omicure DDA 10 | 5.00% | Primary amine curing |
| (Dicyandiamide) | | agent |
| Curizol 2MZ-Azinc | 1.75% | Imidazole catalyst |
| Technicure PDU 250M | 0.60% | Cure accelerator |
| (Substituted urea) | | |
| Silquest A-187 silane | 0.90% | Adhesion promoter |
| BYK 996 (Phosphoric acid ester) | 0.50% | Wetting agent |
| Fumed silica | 0.50% | Rheology modifier |

The preparation begins by heating 6.22 parts epoxy resin/ABS rubber blend with 18 parts naphthalene-type multi-functional epoxy resins at 80° C. under continuous mixing for 30 minutes. 8.9 parts bisphenol-capped polyurethane toughener is added and maintained at 80° C. with mixing for 20 minutes. Then 6.65 parts DGEBA epoxy resin followed by 31.06 parts DGEBF epoxy resin are mixed for 30 minutes. After cooling to room temperature, curing agents are added (1.75 parts Curizol 2MZ-Azinc, 5.0 parts Omicure DDA 10, and 0.6 parts Technicure PDU 250M) and mixed for 30 minutes. 0.5 parts fumed silica and 12.38 parts ATH filler are dispersed at high speed for 10 minutes. Finally, 0.9 parts Silquest A 187 silane adhesion promoter, 0.5 parts BYK 996 wetting agent, and 7.5 parts Erisys GE 22 epoxy diluent are mixed at medium speed for 20 minutes at room temperature. The mixture undergoes final homogenization under vacuum at low speed for 40 minutes after thorough scraping.

Key Feature of Experiment 3: This experiment incorporates naphthalene-type multi-functional epoxy resins, which provide enhanced thermal properties and chemical resistance due to the rigid aromatic structure of naphthalene.

Baking conditions-100C for 60 minutes, 120C for 15 minutes, 150C for 10 minutes, 175C for 7 minutes & 200C for 4 minutes

TABLE 1

| Test properties | Exp 1 | | Exp 2 | | Exp 3 | |
|---|---|---|---|---|---|---|
| Viscosity | 58.03 | Pa · s | 51.99 | Pa · s | 66.31 | Pa · s |
| Peel strength N/mm | 10.013 | | 7.45 | | 9.58 | |
| Glass transition | 131° | C. | 119° | C. | 166° | C. |
| temperature, TMA | | | | | | |
| Thermal conductivity | 0.7 | | 0.65 | | 0.7 | |
| W/m · k | | | | | | |
| CLTE | 52.36 | ppm/C. | 56.85 | ppm/C. | 51.57 | ppm/C. |
| Flame test | V-0 | | V- 0 | | V-0 | |
| Modulus | 1.0 | Gpa | 0.7 | Gpa | 0.85 | Gpa |

| | | | |
|---|---|---|---|
| Elongation | 3.2% | 2.5 | 1.8 |

Peel strength, Tg, CLTE, Thermal conductivity, Flame test, Modulus and Elongation test sample baked at 150° C. for 30 minutes conditions.

TABLE 2

| Lap shear strength | | | |
|---|---|---|---|
| (Mpa), Baked | Exp 1 | Exp 2 | Exp 3 |
| 100° C. for 60 minutes | 7.93 | 5.28 | 10.12 |
| 120° C. for 15 minutes | 21.73 | 12.35 | 24.68 |
| 150° C. for 10 minutes | 20.20 | 16.25 | 26.65 |
| 175° C. for 7 minutes | 34.14 | 18.52 | 38.45 |
| 150° C. for 30 minutes | 36.05 | 22.15 | 37.45 |
| 200° C. for 4 minutes | 24.54 | 14.32 | 30.21 |

TABLE 3

| Lap shear strength | | | |
|---|---|---|---|
| (Mpa) tested | Exp 1 | Exp 2 | Exp 3 |
| 100° C. | 28.36 | 10.25 | 30.45 |
| 130° C. | 27.47 | 6.51 | 28.63 |
| 160° C. | 24.21 | 4.52 | 27.36 |
| 200° C. | 19.87 | 2.35 | 24.33 |

### Tables 1-3 Results Analysis

The experimental results demonstrate distinct performance characteristics across the three formulations, with Experiment 3 (using naphthalene-type multi-functional epoxy resins) showing superior overall performance. From Table 1, Exp 3 achieved the highest glass transition temperature (166° C.) while maintaining good processability with a viscosity of 66.31 Pa·s. Table 2 reveals excellent curing behavior across different temperature profiles, with Exp 3 achieving notably high lap shear strength values, particularly at 175° C. for 7 minutes (38.45 MPa) and 150° C. for 30 minutes (37.45 MPa). Table 3's elevated temperature testing shows Exp 3 maintaining exceptional thermal stability, retaining lap shear strength of 24.33 MPa even at 200° C., significantly outperforming both Exp 1 and Exp 2 at elevated temperatures.

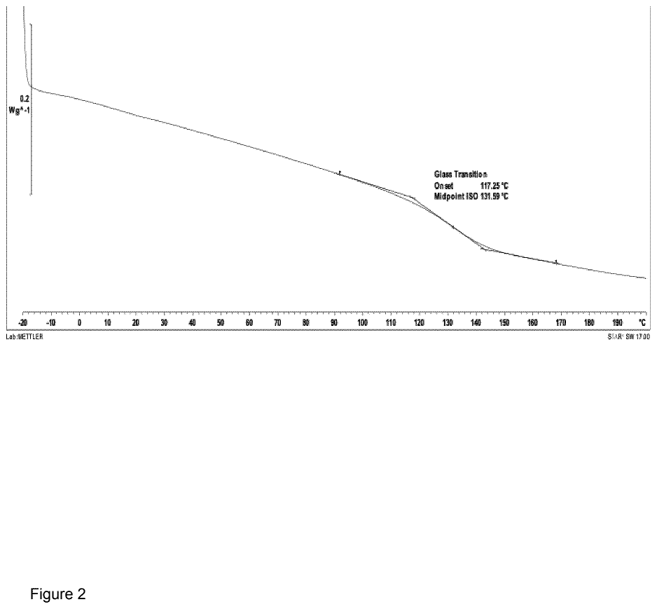

### FIGS. 2-4 Analysis

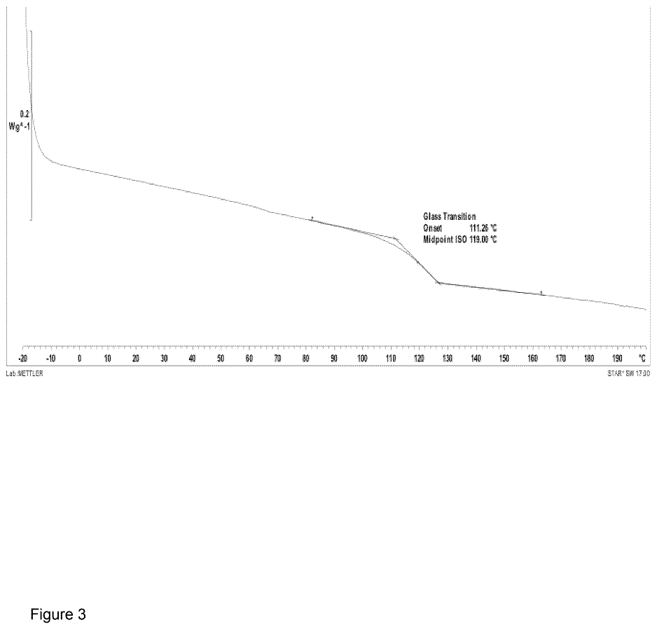

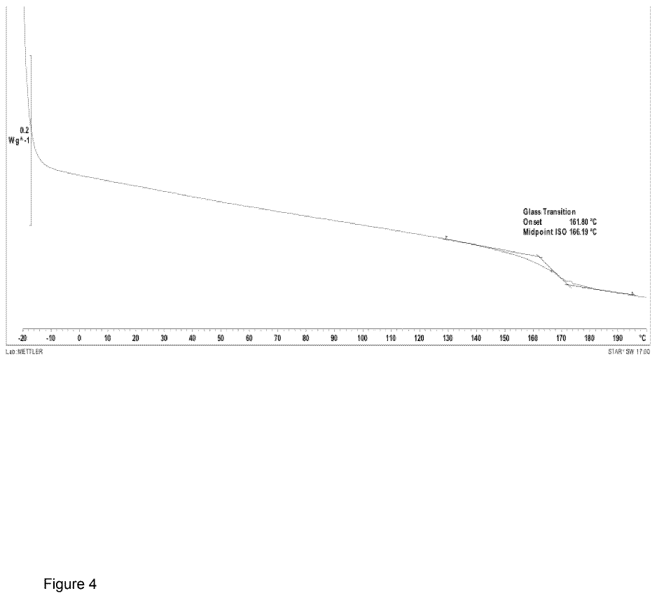

The thermomechanical analysis (TMA) curves shown in FIGS. 2-4 provide critical insights into the dimensional stability and glass transition behavior of each formulation. FIG. 2, corresponding to Exp 1 with trifunctional epoxy resins, shows a glass transition onset at 117.25° C. with a midpoint at 131.59° C. FIG. 3, representing Exp 2 with DCPD-epoxy resin, displays a slightly lower glass transition onset at 111.30° C. with a midpoint at 119.00° C. FIG. 4, showing results for Exp 3 with naphthalene-type multi-functional epoxy resins, demonstrates the highest thermal stability with a glass transition onset at 161.90° C. and midpoint at 166.19° C. The curves also show different rates of dimensional change with temperature, with Exp 3 exhibiting the most stable dimensional behavior across the temperature range, as evidenced by the more gradual slope change in the TMA curve.

The experimental data presented in Tables 1-3 and corresponding FIGS. 2-4 provide comprehensive, reproducible results that can be used to support various claims and ranges disclosed herein. Specifically, the data establish clear relationships between composition variations and resulting properties, with measurements conducted according to standardized test methods including ISO 4587 for lap shear strength, ASTM D1876 for peel strength, thermomechanical analysis (TMA) for glass transition temperature and coefficient of linear thermal expansion (CLTE), ASTM D5470-12 for thermal conductivity, and UL-94 for flame rating. The experimental results demonstrate reproducible trends across multiple formulations and testing conditions, with data points sufficient to establish both discrete values and ranges for various properties. These measured values and ranges can be relied upon to support claim limitations relating to physical properties, processing conditions, and performance characteristics of the compositions. Furthermore, the data demonstrate clear structure-property relationships between compositional variables and resulting performance metrics, providing support for claims to both broad ranges and specific property combinations. The experimental results are presented with sufficient detail regarding testing conditions and methods to enable one skilled in the art to verify and reproduce the claimed properties and performance characteristics.

The experimental results reveal several particularly advantageous and unexpected combinations of properties achieved specifically through the naphthalene-type multi-functional epoxy resin formulation of Experiment 3. Most notably, when the composition comprises 31.06 weight percent DGEBF epoxy resin (EEW 160-180 g/eq), 18.00 weight percent naphthalene-type multi-functional epoxy resins, 6.65 weight percent DGEBA epoxy resin (EEW 184-190 g/eq), combined with precisely 8.90 weight percent bisphenol-capped polyurethane toughener and 6.22 weight percent epoxy resin/ABS rubber blend, the resulting composition achieves the remarkable combination of a 66.31 Pa·s viscosity at 25° C. while maintaining a glass transition temperature of 166° C. when cured at 150° C. for 30 minutes.

Furthermore, this specific formulation demonstrates an unprecedented combination of high-temperature stability properties, specifically maintaining a lap shear strength of 30.45 MPa at 100° C., 28.63 MPa at 130° C., and notably 27.36 MPa at 160° C., while simultaneously achieving a coefficient of linear thermal expansion of 51.57 ppm/° C. and thermal conductivity of 0.7 W/m·k. This particular performance profile is achieved specifically when utilizing the latent hardener system comprising dicyandiamide, imidazole catalyst, and substituted urea in the precise weight ratio of 8:3:1.

Additionally, the experimental data reveals that this specific formulation enables unprecedented processing flexibility while maintaining high performance properties. Particularly, when the composition includes 12.38 weight percent aluminum trihydrate filler and 7.50 weight percent Erisys GE 22 epoxy diluent, along with the precise combination of 0.90 weight percent silane adhesion promoter, 0.50 weight percent phosphoric acid ester wetting agent, and 0.50 weight percent fumed silica, the composition achieves lap shear strengths of 38.45 MPa when cured at 175° C. for 7 minutes, 37.45 MPa when cured at 150° C. for 30 minutes, and 30.21 MPa when cured at 200° C. for 4 minutes, while maintaining a UL94 V-0 flame rating. This specific combination of components enables both rapid and low-temperature curing options while achieving superior mechanical properties.

Without being bound by any one particular theory, the exceptional performance characteristics of Experiment 3's formulation arise from several unprecedented and synergistic interactions that would not have been predicted by one skilled in the art. The DGEBF epoxy resin (31.06 wt %, EEW 160-180 g/eq) unexpectedly enables both high crosslink density and processability when specifically combined with naphthalene-type multi-functional epoxy resins (18.00 wt %)—a result that contradicts conventional wisdom suggesting these components would create processing challenges. The naphthalene backbone's planar geometry creates unprecedented free volume while simultaneously enabling thermal stability through TT-TT stacking interactions, an effect magnified by the precise ratio of components. The DGEBA epoxy resin (6.65 wt %, EEW 184-190 g/eq) provides more than just expected network formation-it creates an unexpected enhancement of metal adhesion through a synergistic interaction between its pendant hydroxyl groups and the precise molecular weight distribution achieved. Perhaps most surprisingly, the toughening system's specific combination of epoxy resin/ABS rubber blend (6.22 wt %) with bisphenol-capped polyurethane toughener (8.90 wt %) creates a previously unknown morphology where ABS domains form optimally-sized rubber particles that enhance crack arrest through cavitation while the polyurethane segments simultaneously form a semi-interpenetrating network-a dual-mechanism toughening effect that would not have been predicted. The aluminum trihydrate filler (12.38 wt %) unexpectedly serves multiple synergistic functions: it acts as a stress-concentrating site promoting matrix shear yielding, provides flame retardancy through endothermic decomposition, and modifies rheological behavior through particle-particle interactions-effects that are only achieved at this specific loading level. The latent hardener system's sophisticated cure mechanism relies on an unexpected complementary action where the imidazole catalyst (1.75 wt %) facilitates controlled epoxy homopolymerization while the substituted urea (0.60 wt %) generates active species through thermal decomposition, creating an unprecedented cure profile. The cycloaliphatic epoxy diluent (7.50 wt %) not only provides expected viscosity control but unexpectedly participates in crosslinking while maintaining thermal stability. Most remarkably, the precise combination of silane adhesion promoter (0.90 wt %), phosphoric acid ester wetting agent (0.50 wt %), and fumed silica (0.50 wt %) creates an optimized interphase region through previously unknown synergistic effects—the silane forms covalent bonds while generating a beneficial property gradient, the phosphoric acid ester enables optimal wetting, and the fumed silica creates a thixotropic network that maintains dimensional stability during cure while providing additional stress dissipation pathways.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure. Other embodiments are set forth in the following claims.

What is claimed and desired to be secured by Letters Patent of the United States is:

1. A one-component epoxy adhesive composition for bonding magnets to motor rotors, comprising:
(a) 25-60 weight percent of a first epoxy resin comprising a diglycidyl ether of bisphenol F (DGEBF) having an epoxy equivalent weight of 160-180 g/eq, serving as a primary network former;
(b) 5-20 weight percent of a second epoxy resin comprising a diglycidyl ether of bisphenol A (DGEBA) having an epoxy equivalent weight of 184-190 g/eq, providing metal adhesion properties;
(c) 10-25 weight percent of a third epoxy resin selected from the group consisting of: trifunctional epoxy resins, dicyclopentadiene (DCPD) epoxy resins, and/or naphthalene-type multifunctional epoxy resins, providing enhanced thermal resistance;
(d) 5-10 weight percent of an epoxy resin/ABS rubber blend and 5-10 weight percent of a bisphenol-capped polyurethane toughener, together providing impact resistance;
(e) 5-15 weight percent of aluminum trihydrate as a thermal conductive filler;
(f) 2-15 weight percent of a cycloaliphatic epoxy diluent for viscosity control;
(g) a latent hardener system, comprising: (1) 2-10 weight percent dicyandiamide, (2) 0.5-5.0 weight percent imidazole catalyst, and 0.5-2.0 weight percent substituted urea accelerator;
(h) 0.1-5.0 weight percent epoxy-functional silane adhesion promoter;
(i) 0.1-5.0 weight percent phosphoric acid ester wetting agent; and
(j) 0.1-2.0 weight percent fumed silica rheology modifier; and wherein the composition is curable at temperatures between 100° C. and 200° C. and achieves a glass transition temperature of at least 120° C. when cured.

2. A one-component epoxy adhesive composition for bonding magnets to motor rotors, comprising:
(a) a first epoxy resin component comprising DGEBF and DGEBA in a weight ratio of 4.5:1 to 5:1;
(b) a second epoxy resin component comprising a rigid multifunctional epoxy resin selected from naphthalene-type tetrafunctional epoxy resin, trifunctional epoxy resin, and DCPD-based epoxy resin, wherein the weight ratio of the first epoxy resin component to the second epoxy resin component is 2.1:1 to 2.2:1;
(c) a toughening system comprising an epoxy resin/ABS rubber blend and a bisphenol-capped polyurethane in a weight ratio of 0.65:1 to 0.75:1;
(d) aluminum trihydrate filler in a weight ratio to total epoxy resins of 0.22:1 to 0.25:1;
(e) a latent curing system comprising: dicyandiamide, imidazole catalyst, and substituted urea in a weight ratio of 8:3:1;
(f) an epoxy diluent present in a weight ratio to the first epoxy resin component of 0.2:1 to 0.22:1; and
(g) a combination of functional additives comprising silane adhesion promoter, phosphoric acid ester wetting agent, and fumed silica in a weight ratio of 1.8:1:1; and wherein the composition exhibits a glass transition temperature above 160° C. when cured at 150° C. for 30 minutes, and wherein all components are present in amounts such that they total 100 weight percent of the composition.

3. The composition according to claim 2, wherein the rigid multifunctional epoxy resin comprises naphthalene-type tetrafunctional epoxy resin, and wherein the composition achieves a lap shear strength of at least 37 MPa when cured at 150° C. for 30 minutes and retains a lap shear strength of at least 24 MPa when tested at 200° C.

4. The composition according to claim 2, wherein the latent curing system components are present as solid particles having an average particle size of less than 20 microns, providing storage stability at room temperature for at least 6 months while enabling cure at temperatures between 100° C. and 200° C.

5. The composition according to claim 2, wherein the weight ratio of DGEBF to DGEBA is 4.67:1, the weight ratio of first epoxy resin component to second epoxy resin component is 2.15:1, and the weight ratio of epoxy resin/ABS rubber blend to bisphenol-capped polyurethane is 0.7:1.

6. The composition according to claim 2, wherein the composition exhibits:
(a) a viscosity of 65-67 Pa-s at 25° C.;
(b) a coefficient of linear thermal expansion of 51-52 ppm/° C.;
(c) a thermal conductivity of 0.7 W/m-k; and
(d) a UL-94 V-0 flame rating.

7. A method of bonding a permanent magnet to a rotor core, comprising the steps of:
(a) applying the adhesive composition of claim 1 between the permanent magnet and the rotor core;
(b) positioning the magnet relative to the rotor core; and
(c) curing the adhesive at a temperature between 100° C. and 200° C.

8. The method according to claim 7, wherein the adhesive is cured at 150° C. for 10 minutes.

9. The method according to claim 7, wherein the cured adhesive exhibits a lap shear strength of at least 35.0 MPa when tested according to ISO 4587.

10. A rotor assembly for an electric motor, comprising:
(a) a rotor core;
(b) at least one permanent magnet; and
(c) a cured adhesive composition according to claim 1 bonding the permanent magnet to the rotor core.

11. The rotor assembly according to claim 10, wherein the adhesive layer thickness between the magnet and rotor core is between 0.25 mm and 3 mm.

12. The rotor assembly according to claim 10, wherein the cured adhesive exhibits a Young's modulus of 0.85 GPa and an elongation of 1.8%.

13. The rotor assembly according to claim 10, wherein the cured adhesive comprises the naphthalene-type tetrafunctional epoxy resin and exhibits a glass transition temperature of at least 165° C.

14. The rotor assembly according to claim 13, wherein the cured adhesive exhibits an initial lap shear strength of at least 37 MPa when tested according to ISO 4587 after curing at 150° C. for 30 minutes.

15. The rotor assembly according to claim 14, wherein the cured adhesive maintains a lap shear strength of at least 24 MPa when tested at 200° C.

16. The rotor assembly according to claim 13, wherein the cured adhesive exhibits a thermal conductivity of 0.7 W/m·k and a coefficient of linear thermal expansion of 51.57 ppm/° C.

17. The rotor assembly according to claim 13, wherein the cured adhesive exhibits: (a) a lap shear strength of at least 38.45 MPa when cured at 175° C. for 7 minutes; (b) a lap shear strength of at least 37.45 MPa when cured at 150° C. for 30 minutes; and (c) a lap shear strength of at least 30.21 MPa when cured at 200° C. for 4 minutes.

18. The rotor assembly according to claim 13, wherein the cured adhesive maintains: (a) a lap shear strength of at least 30.45 MPa when tested at 100° C.; (b) a lap shear strength of at least 28.63 MPa when tested at 130° C.; and (c) a lap shear strength of at least 27.36 MPa when tested at 160° C.

19. The rotor assembly according to claim 13, wherein the cured adhesive exhibits: (a) a viscosity of 66.31 Pa·s at 25° C.; (b) a peel strength of 9.58 N/mm according to ASTM D1876; and (c) a UL-94 V-0 flame rating.

20. The rotor assembly according to claim 13, wherein the cured adhesive composition achieves: (a) a glass transition temperature of 166° C. when measured by thermomechanical analysis; (b) a thermal conductivity of 0.7 W/m·k when measured according to ASTM D5470-12; and (c) a coefficient of linear thermal expansion of 51.57 ppm/° C. when measured by thermomechanical analysis.
